(19) United States
(12) Patent Application Publication
(10) Pub. No.: US 2016/0232462 A1
(43) Pub. Date: Aug. 11, 2016

(54) Methods And Systems For Providing Management Service

(71) Applicants: Stacy Woodward, Katy, TX (US); Timothy S. Webster, OakBrook Terrace, IL (US); Dana E. Bolton, Chicago, IL (US); L. Jared Bulloch, Katy, TX (US); Rajan P. Vora, Sugarland, TX (US); Sunil Garg, Chicago, IL (US)

(72) Inventors: Stacy Woodward, Katy, TX (US); Timothy S. Webster, OakBrook Terrace, IL (US); Dana E. Bolton, Chicago, IL (US); L. Jared Bulloch, Katy, TX (US); Rajan P. Vora, Sugarland, TX (US); Sunil Garg, Chicago, IL (US)

(21) Appl. No.: 14/617,475

(22) Filed: Feb. 9, 2015

(51) Int. Cl. G06Q 10/06

(52) U.S. Cl. CPC G06Q 10/067

(57) ABSTRACT

Provided are methods and systems for providing management service. An example method can comprise receiving information related to a plurality of the members of an organization and information related to a plurality of characteristics of the organization and classifying the received information. A service request related to the organization or to one or more of the plurality of members of the organization can be received. A module from a plurality of modules can be identified to process the service request according to the classified information. In an aspect, the plurality of modules can be interconnected. A result can be generated via processing the service request using the identified module. One or more recommendations can be provided based on the generated result using one or more of the plurality of modules connected to the identified module.

### BACKGROUND

Organizations often have a large quantity of detailed information on skills and personal qualities of its members and characteristics of the organization. Members of an organization often have a need to navigate through the structure of the organization, which can oftentimes be found in the detailed information. Current centralized command and control or “top-down” management practices do not utilize available information of an organization to its fullest potential. There is therefore a need for improved methods and systems of exploiting available information to enhance the effectiveness of organization management.

### SUMMARY

It is to be understood that both the following general description and the following detailed description are exemplary and explanatory only and are not restrictive, as claimed. Provided are methods and systems for providing management service. The disclosed methods and systems can utilize information related to members and characteristics of an organization, foster knowledge sharing and career development, foster collaboration, and enhance effectiveness of the organization management. In an aspect, the disclosed methods and systems can be used to identify a specific member or a team to perform a certain task, connect two or more members for a specific purpose, facilitate objectivity in compensation and promotional decisions, align member's passion with work, plan a career path, promote collaboration and innovation, increase member satisfaction and productivity, increase retention, requesting feedback, analyzing team strength and development needs, and make member's contribution more visible.

An example method can comprise receiving information related to a plurality of members of an organization and information related to a plurality of characteristics of the organization. The received information can be classified. A service request related to the organization or to one or more of the plurality of members of the organization can be received. A module can be identified from a plurality of modules to process the service request. In an aspect, the plurality of modules are interconnected. A result can be generated via processing the service request based on the classified information using the identified module. One or more recommendations can be provided based on the generated result using one or more of the plurality of modules connected to the identified module.

Another example method can comprise receiving information related to a plurality of the members of an organization and information related to a plurality of characteristics of the organization. The received information can be classified. A collaboration quotient can be determined based on the classified information using one or more modules (e.g., a collaboration module). A collaboration status for one or more of the plurality of members can be determined based on the determined collaboration quotient.

Another example method can comprise receiving information related to a plurality of the members of an organization and information related to a plurality of characteristics of the organization. The received information can be classified. A service request to identify a career path for a specific member of the organization can be received. A visual role chart can be retrieved. One or more career paths can be determined based on the retrieved visual role chart and information related to the specific member via a career path module. One or more recommendations can be provided to the specific member based on the identified one or more career paths via one or more modules connected to the career path module.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram illustrating an example system environment in which the present systems and methods can operate;

FIG. 2 is a block diagram illustrating an example information classification;

FIG. 3 is a flowchart illustrating an example method for providing a management service;

FIG. 4 is a flowchart illustrating another example method for providing a management service;

FIG. 5 is a flowchart illustrating another example method for providing a management service; and

FIG. 6 is a block diagram illustrating an example computing device in which the present systems and methods can operate.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Provided are methods and systems for providing a management service. An example method can comprise receiving information related to a plurality of members of an organization and information related to a plurality of characteristics of the organization. The received information can then be classified. For example, a robust taxonomy on member information (e.g., position, skills, education, etc.) can be created. A service request related to the organization or to one or more of the plurality of members of the organization can be received. A module can be identified from a plurality of modules to process the service request. In an aspect, the plurality of modules can be interconnected. A result can be generated via processing the service request based on the classified information using the identified module.

One or more recommendations can be provided based on the generated result using one or more of the plurality of modules connected to the identified module. As an example, the plurality of modules can comprise a career path module, a skill gap module, a feedback module, a mentoring module, a training module, an achievement module, a collaboration module, and other modules. In an aspect, using one module can automatically trigger using one or more other modules. For example, when a member's career path is identified, one or more other modules such as the skill gap module, the feedback module, the mentoring module, the training module, and the like, can be used to provide more information related to the result generated by the career path module. For example, the skill gap module can provide recommendations on skills that need to be acquired or improved for a specific member to move to a next role on the identified career path. As another example, the mentoring module can recommend one or more mentors to help the specific member to achieve his or her goal on the identified career path or recommend one or more mentors to improve one or more skills identified in the skill gap module. As another example, the training module can be used to recommend one or more training courses (e.g., on-line courses, instructor led, etc.) to fill skill gaps for the specific member to achieve his goal on his career path.

In an aspect, the disclosed systems and methods can utilize a decentralized method for gathering information, enabling input and opinions from all members and about all members. In an aspect, information associated with a member can be received via a member's self-evaluation information, confidential feedback information from the member's colleagues/supervisors, one or more actions taken by one or more of the plurality of members, and/or the like. For example, a member can update his profile in real time by logging into his account. As another example, a member's colleague can provide feedback to the member. In an aspect, a comparison between self-evaluation information and feedback information can be made to obtain accurate information about the member. In an aspect, a member can choose to share the confidential feedback with his or her manager, supervisor, and/or one or more colleagues.

By way of example, information associated with a member can comprise personal information, job related information, skill related information, and other information. As an example, personal information can comprise information such as name, address, email address, hobby, role model, personal preference, and the like. As another example, job related information can comprise information such as current position, manager's name, team description, career track, career goal, mentoring actions, collaboration actions, badges, endorsements, thank-you recognitions, training courses taken, and the like. As another example, skill related information can comprise information such as programming skills, communication skills, language skills, management skills, conceptual thinking skills, conflict resolution skills, industry skills such as energy trading skills, energy generation skills, business acumen, and the like.

As another example, the information related to one or more characteristics of the organization can comprise a role requirement, a role status, a role skill level requirement, a role family, a role level, a role track, a role discipline, a role location, a certification requirement, a training resource, and a pay level associated with one or more roles within the organization.

The disclosed methods and systems can connect people, programs, and other information of an organization for career development and knowledge sharing. In an aspect, the disclosed methods and systems can be used to develop, reward, and retain talent and expertise, provide members (e.g., employees, contractors, volunteers, etc.) with valuable career resources within an organization, and facilitate effective contribution of members to an organization. The disclosed methods and systems can broaden experience, skills and business acumen of members by increasing member movement between roles, projects, and learning

In an aspect, the disclosed methods and systems can be used to identify the right member or team to do the right work, enhance employee satisfaction and productivity, facilitate objectivity in compensation and promotional decisions, and align a member's passion with work. In another aspect, the disclosed methods and systems can be used to increase collective collaboration, stimulate innovation, plan a career path, and make a member's contribution more visible.

In an aspect, the disclosed methods and systems can enable members of an organization to take ownership and take action in their professional career development. For example, a member (e.g., an employee) can identify and connect with other members that can help his career development and/or leverage other member's expertise (e.g., mentor's expertise). The disclosed systems and methods can expose an aggregate view of all members related to their strengths and abilities. In an aspect, members of an organization can establish a professional reputation and/or increase exposure within the organization with regards to their abilities and contributions across disparate geography and different levels of decision makers. In another aspect, a member can be provided with information to identify his career path within an organization.

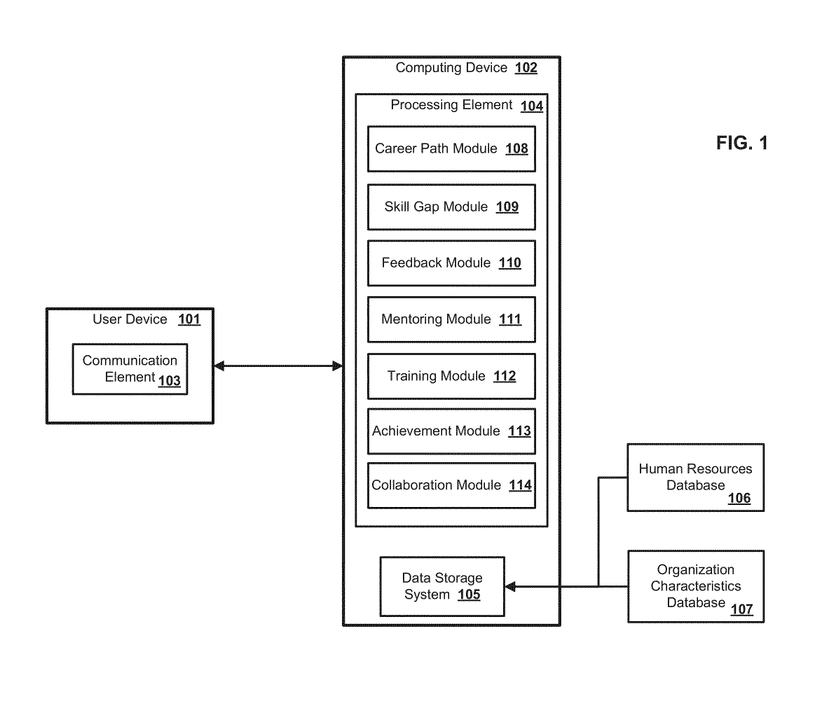

FIG. 1 illustrates various aspects of an exemplary system in which the present methods and systems can operate. In an aspect, the system can comprise a user device 101 and a computing device 102. As an example, the user device 101 can comprise a computer, a smart phone, a tablet, a mobile device, a PDA, a communications terminal, and/or the like. As an example, the computing device 102 can be a personal computer, a portable computer, a smartphone, a server, a router, a network computer, a peer device, a network node, and/or the like. As an example, the computing device 102 can communicate with the user device 101 for providing data and/or services. Specifically, the computing device 102 can provide management services for one or more organizations.

In an aspect, the computing device 102 can be configured as (or disposed at) a central location (e.g., a headend, or processing facility, a data center, a managed facility), which can receive content (e.g., data, input programming) from multiple sources. In an aspect, the computing device 102 does not need to be in a fixed location or in the cloud. The user device 101 can be used in any location convenient to communicate with the computing device 102. The computing device 102 can be set up by installing and configuring applications, services and databases.

In an aspect, the user device 101 can comprise a user interface for sending a service request related to an organization or one or more of the plurality of members of the organization. In an aspect, the computing device 102 can comprise a server for providing data and/or services (e.g., management service).

In an aspect, the user device 101 can communicate with the computing device 102 by a communication element 103. The communication element 103 can be a user interface configured to enable communications between the user device 101 and the computing devices 102 via a wired and/or wireless network using Wi-Fi, Bluetooth, MoCa, DLNA, Ethernet or any desired method or standard. As an example, communication element 103 can comprise software, hardware, and/or interfaces for presenting and/or receiving information to/from the user of the user device 101, such as a service request for identifying a career path. As an example, the communication element 103 can request or query various files from a local source and/or a remote source. As a further example, the communication element 103 can transmit data (e.g., service request data) to a local or remote device such as the computing device 102.

In an aspect, the computing device 102 can comprise a processing element 104 and a data storage system 105. The processing element 104 can be configured to process a service request received from the communication element 103. In an aspect, the processing element 104 can comprise a plurality of interconnected modules. For example, the processing element 104 can comprise a career path module 108, a skill gap module 109, a feedback module 110, a mentoring module 111, a training module 112, an achievement module 113, a collaboration module 114, and other modules. A specific module can be selected to process a specific type of service request. For example, if the service request comprises identifying a career path for a specific member, the career path module 108 can be used. When a member's career path is determined, one or more other modules connected to the career path module 108 such as the skill gap module 109, the feedback module 110, the mentoring module 111, the training module 112 can be used to provide more information related to result generated by the career path module 108. For example, the skill gap module 109 can provide recommendations on skills that need to be acquired or improved for specific member based on the identified career path. As another example, the mentoring module 111 can recommend one or more mentors to help the specific member to progress along his career path. As another example, the training module 112 can recommend one or more training courses (e.g., online courses) to fill the skill gap for the specific member to be on his career path.

The processing element 104 can access or retrieve information stored in the data storage system 105. The data storage system 105 can be configured to store information related to a plurality of members of an organization and information related to a plurality of characteristics of the organization. In an aspect, the data storage system 105 can communicate with one or more databases for storing a plurality of files (e.g., web pages, data records), member information, organization characteristics information, polices, records, or other information. For example, the data storage system 105 can be connected to a human resources database 106 and/or an organization characteristics database 107 via, for example, a network service.

Any information can be stored in and retrieved from the data storage system 105. In an aspect, the data storage system 105 can be disposed remotely from the computing device 102 and accessed via direct or indirect connection. The data storage system 105 can be integrated with the computing system 102 or some other device or system.

In an aspect, the human resources database 106 can comprise a member identifier, first name, last name, work phone number, mobile phone number, address, email address, employee department number, department description, pay grade, manager name, member identifier, member status (e.g., full time, pert time, contractor, volunteer), location identifier, location description, position title, effective date associated with the position title, other information, and the like.

In an aspect, data stored in the in the data storage system 105, human resources database 106, and/or organization characteristics database 107 can be encrypted, for example, using a public key. In an aspect, an encrypted data feed between databases can be decrypted. In an aspect, data of the human resources database 106, and/or organization characteristics database 107 can be fed to the data storage system 105 at a specific frequency. An example data feeding process is indicated in Table 1:

TABLE 1

| DATA | | | |
|---|---|---|---|
| FEED | FREQUENCY | MECHANISM | NOTES |
| One Time | Once | Batch File | Comma separated values |
| Feed | | | (CSV) File that can be |
| | | | generated once and sent |
| | | | manually |
| Full Feed | Once a day or | FTP with pretty | comma separated values |
| | real time via a | good privacy | (CSV) File |
| | network service | (PGP) file | |
| | | encryption | |

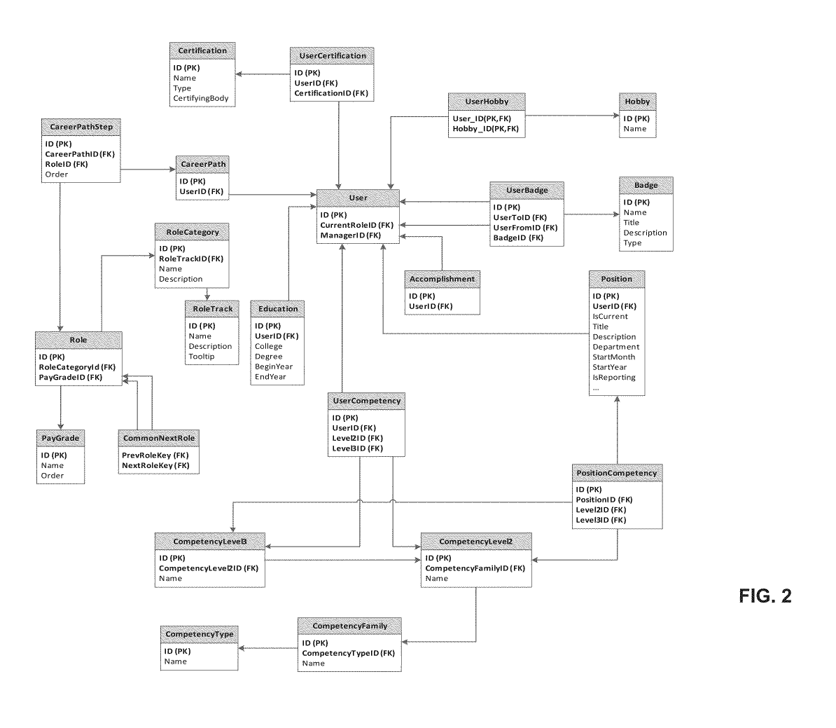

FIG. 2 is a block diagram illustrating an example information classification. In an aspect, a robust taxonomy on member information (e.g., position, hobby, education, etc.) and organization characteristics information (e.g., role, common next role, role category, etc.) can be used, providing an accurate information classification. In an aspect, each box in FIG. 2 can represent a table with a plurality of columns. A table can be connected to another table by one or more arrows. In an aspect, a “user table” can be a parent table and a plurality of tables (e.g., user badge table, accomplishment table, user hobby table, etc.) connected to the user table can be a plurality of children tables. A plurality of tables in FIG. 2 can be connected via one-to-many, many-to-one, or one-to-one relationships. Data in parent tables and/or child tables can be queried and presented through a user interface.

In another aspect, a decentralized method can be used to gather information from all members and about all members. For example, information associated with each member (e.g., employee) can comprise member's self-evaluation information and feedback information from the member's colleagues. A comparison between self-evaluation information and feedback information can be made. For example, a member can update his profile (e.g., education information, skill set, recent collaboration activity, mentoring activity, other actions, etc.) by logging into his account. As another example, a member profile can comprise other member's (e.g., the member's supervisor, the member's peers, etc.) feedback. In an aspect, the feedback can be anonymous. The methods and systems can generate an aggregate view of all members.

In an aspect, the classified information can be set at different privacy levels. For example, a portion of the classified information can be set as private. Information such as feedback from other members, career path information, target skills, skill gap analysis, and mentoring information can be set as private information. A member can choose to share a portion or all of his private information with another member. As another example, a portion of the classified information such as name, position, acknowledgements, achievements, training, skill set, work phone number, email address, employee department number, department description, and the like, can be set as public information. In an aspect, every member of an organization can view the public information.

In an aspect, a robust skill taxonomy can be used based on the information of the plurality of members to ensure an accurate skill classification. For example, skill information can be categorized as different types of personal skills (e.g., adaptability, discipline, motivation, self-development, etc.), different types of management skills (e.g., oral communications, written communication skills, interpersonal skills, execution skills, encouraging open dialogue skills, etc.), different types of business skills (e.g., client identification skills, client development skills, event planning skills, etc.), different types of specialty skills (e.g., Java programming skills, C programming skills, data encryption skills, etc.), and the like. In another aspect, each skill can be associated with a proficiency level (e.g., entry level, mid-level, high level, advanced level, etc.). In an aspect, each skill can be marked with a relevance level (e.g., not relevant, preferred, required, etc.) for a specific role or position within an organization. In an aspect, an average proficiency level of a specific skill for a specific role or position within an organization can be calculated. In an aspect, information related to a member can indicate skills the member is passionate about and skills the member wants to improve. A user can search for a mentor and/or training courses specific to the skills.

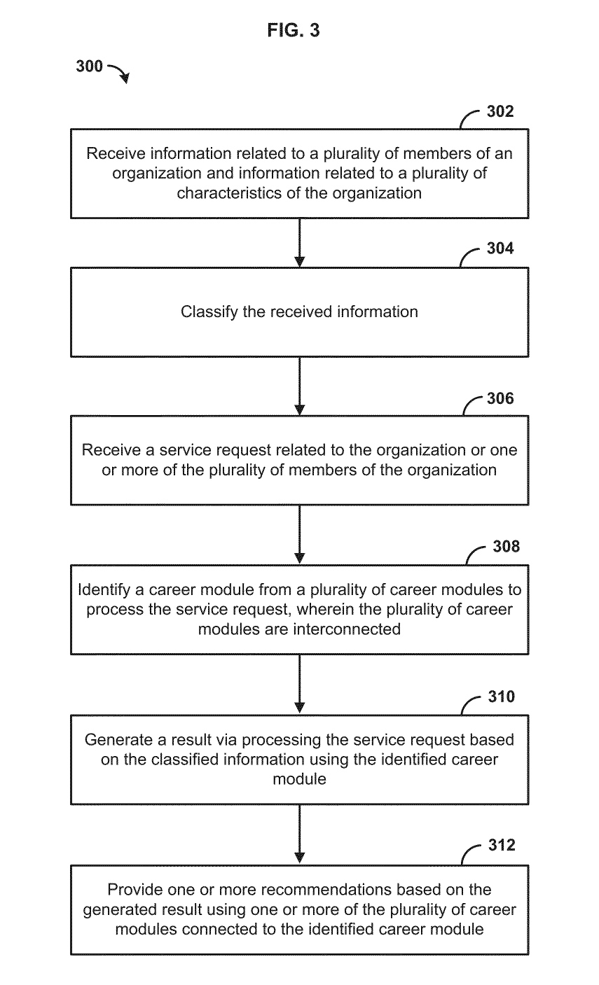

FIG. 3 is a flowchart illustrating an example method 300 for providing management service. At step 302, information related to a plurality of members of an organization and information related to a plurality of characteristics of the organization can be received. In an aspect, the received information can be stored in a data storage system (e.g., data storage system 105).

In an aspect, the information related to a plurality of members of the organization can comprise member personal information, job related information, education related information, skill related information, and other information. As an example, personal information can comprise information such as name, address, email address, phone number, hobby, role model, and the like. As another example, job related information can comprise information such as current position, team description, career track, career goal, and the like. As another example, skill related information can comprise information such as programming skills, communication skills, language skills, management skills, conceptual thinking skills, conflict resolution skills, and the like. As an example, the information related to the plurality of members of the organization can comprise one or more of a member identifier, name, gender, phone number, address, email address, department number, department description, pay grade, member status (e.g., full time, part time, contractor, volunteer), location, location description, position title, career trajectory, career goal, education level, hobby, achievements, skills, mentoring actions, collaboration actions, feedbacks given, and feedback received, endorsement given, mentor-mentee relationships, and enrolled training courses associated with the respective plurality of members of an organization, badges, endorsements, thank-you recognitions. In an aspect, the information related to the plurality of members of an organization can be received from a human resources database. In an aspect, the information related to the plurality of members of the organization can be updated at a predefined frequency (e.g., once a day, once a week, once a month). In another aspect, the information related to the plurality of members of the organization can be updated in real-time (e.g., via logging into a members account). In an aspect, the information related to the plurality of members of the organization can be received from one or more of a survey, a self-evaluation, a peer evaluation associated with the plurality of members, and/or one or more actions taken by one or more of the plurality of members.

In an aspect, information related to the plurality of characteristics of the organization can comprise a role requirement, a role status, a role skill level requirement, a role family, a role level, a role track, a role discipline, a role location, a certification requirement, a training resource, and a pay level associated with one or more roles within the organization. In an aspect, the information related to the plurality of characteristics of the organization is determined by status, policy, and task requirements of the organization.

At step 304, the received information can be classified. For example, a robust skill taxonomy can be used based on the information of the plurality of members to ensure an accurate skill classification. For example, skill information can be categorized as different types of personal skills (e.g., adaptability, discipline, motivation, self-development, etc.), different types of management skills (e.g., oral communications, written communication skills, interpersonal skills, etc.), different types of business skills (e.g., client identification skills, client development skills, event planning skills, etc.), different types of specialty skills (e.g., Java programming skills, C programming skills, data encryption skills, etc.), and the like. Different types of information can be classified by different types of taxonomy.

In an aspect, the information can be assigned a weight. The assigned weight can change based on a specific service request. As an example, programming skills information can be assigned a higher weight than other skills for a service request to identify a candidate for a programmer position. As another example, communication skills can be assigned a higher weight than other skills for a service request to identify a candidate for management position. As another example, one or more recent actions (e.g., collaboration actions) can be assigned a higher weight than actions (e.g., collaboration actions) that occurred in previous years for a service request that identify a candidate for an award for a current year.

At step 306, a service request related to the organization or to one or more of the members of the organization can be received. In an aspect, the service request related to one or more of the plurality of members of the organization can comprise one or more of: determining a career path for a member, identifying a member as a candidate for a specific position, determining a contribution of a member, determining one or more members for a specific task, determining promotion for a member, evaluating a member, rewarding a member, connecting one or more members with one or more specific common interests, skills, and career goals, and connecting one or more members to one or more open positions, identifying one or more skills for a member to develop, providing a resource for a member, connecting one or more members who need to develop a skill to one or more members who can have the skill, connecting two or more members for a specific purpose, analyzing team strength and development needs, requesting or receiving feedback, and the like. As a specific example, the service request can comprise identifying a specific member (e.g., employee) as a candidate for a specific position (e.g., leadership position, management position, mentor position, etc.), and/or can be potentially recognized for his positive influences and contribution.

At step 308, a module can be identified from a plurality of modules to process the service request. In an aspect, the plurality of career modules can be interconnected. For example, a processing element (e.g., a processing element 104) can comprise a plurality of interconnected modules, such as a career path module, a skill gap module, a feedback module, a mentoring module, a training module, an achievement module, a collaboration module, and other modules. A specific module can be selected to process a specific type of service request. For example, if the service request comprises identifying a career path for a specific member, the career path module can be used. If the service request comprises identify one or more mentors for a specific member, the mentoring module can be used. As another example, if the service request comprises identifying an award for a specific member, an achievement module can be used.

At step 310, a result can be generated via processing the service request using the identified module. For example, when the service request comprises identifying a career path for a specific member, the career path module can retrieve a visual role chart based on career trajectories of one or more of the plurality of members with similar education information, working history, and skills. In an aspect, the visual role chart can comprise one or more career paths between one specific position and another specific position and time associated with the one or more career paths. One or more career paths can be determined based on matching education information, working history, career goals and skills of the specific member and one or more career paths in the visual role chart.

At step 312, one or more recommendations can be provided based on the generated result using one or more of the plurality of modules connected to the identified module. For example, when a member's career path is identified by a career path module, one or more other modules connect to the career path module such as a skill gap module, a feedback module, a mentoring module, a training module, can be used to provide more information related to the result. For example, the skill gap module can provide recommendations on skills that need to be acquired or improved for a specific member based on the identified career path. As another example, the mentoring module can recommend one or more mentors to help the specific member to along his career path. As another example, the training module can be used to recommend one or more training courses to fill the skill gap for the specific member to maintain pace on his career path.

In an aspect, badges (e.g., small images) can be used to flag achievement/contributions by members. For example, if a member has mentored a certain number of members, an achievement module can provide an achievement badge (e.g., mentor guru, mentor master, etc.) to the member. The member can choose to display the achievement badge on his profile. Similarly, when a member has formed a certain number of productive collaborations with other members of the organization, the collaboration module (e.g., collaboration module 114) can provide a collaboration report for the member (e.g., previous collaborators, productive collaboration projects, etc.). The member can choose to display the collaboration report on his profile. In a further aspect, a member can thank another member through the system. For example, in the event one member helps another member (e.g., as a mentor, on a project, etc. . . . ) the member that was helped can use the system to transmit a virtual thank you to the helping member. The thank you can be in the form of a badge, message, and the like.

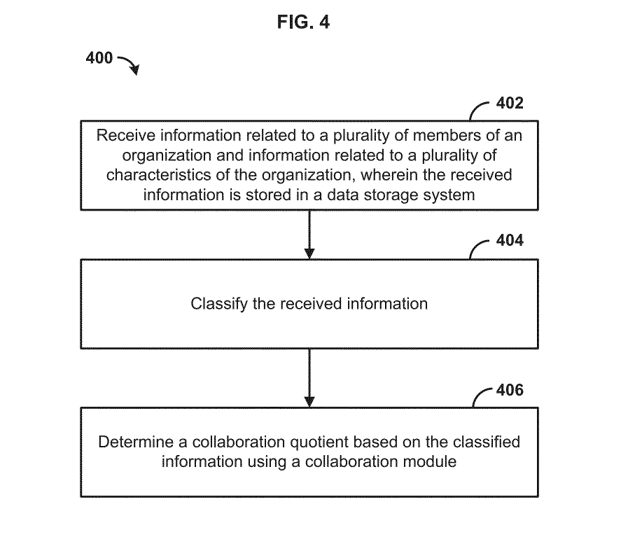

FIG. 4 is a flowchart illustrating an example method 400. At step 402, information related to a plurality of members of an organization and information related to a plurality of characteristics of the organization can be received. In an aspect, the received information can be stored in a data storage system (e.g., data storage system 105).

In an aspect, the information related to a plurality of members of the organization can comprise member personal information, job related information, education related information, skill related information, and other information. As an example, personal information can comprise information such as name, address, email address, phone number, hobby, role model, and the like. As another example, job related information can comprise information such as current position, team description, career track, career goal, and the like. As another example, skill related information can comprise information such as programming skills, communication skills, language skills, management skills, conceptual thinking skills, conflict resolution skills, and the like. As an example, the information related to the plurality of members of the organization can comprise one or more of a member identifier, name, gender, phone number, address, email address, department number, department description, pay grade, member status (e.g., full time, part time, contractor, volunteer), location, location description, position title, career trajectory, career goal, education level, hobby, achievements, skills, mentoring actions, collaboration actions, feedbacks given, and feedback received, endorsement given, mentor-mentee relationships, and enrolled training courses associated with the respective plurality of members of an organization, badges, endorsements, thank-you recognitions. In an aspect, the information related to the plurality of members of an organization can be received from a human resources database. In an aspect, the information related to the plurality of members of the organization can be updated at a predefined frequency (e.g., once a day, once a week, once a month). In another aspect, the information related to the plurality of members of the organization can be updated in real-time (e.g., via logging into a members account). In an aspect, the information related to the plurality of members of the organization can be received from one or more of a survey, a self-evaluation, a peer evaluation associated with the plurality of members, and one or more actions taken by one or more of the plurality of members.

In an aspect, information related to the plurality of characteristics of the organization can comprise a role requirement, a role status, a role skill level requirement, a role family, a role level, a role track, a role discipline, a role location, a certification requirement, a training resource, and a pay level associated with one or more roles within the organization. In an aspect, the information related to the plurality of characteristics of the organization is determined by status, policy and task requirements of the organization.

At step 404, the received information can be classified. For example, a robust skill taxonomy can be used based on the information of the plurality of members to ensure an accurate skill classification. For example, skill information can be categorized as different types of personal skills (e.g., adaptability, discipline, motivation, self-development, etc.), different types of management skills (e.g., oral communications, written communication skills, interpersonal skills, etc.), different types of business skills (e.g., client identification skills, client development skills, event planning skills, etc.), different types of specialty skills (e.g., Java programming skills, C programming skills, data encryption skills, etc.), and the like.

As another example, the information can be classified in a plurality of categories such as “helping other members,” “self-improvement,” “connectedness,” that correspond to how many other members a member has helped, how many self-improvement actions a member has performed, how many interactions have taken place between the member and other members. In an aspect, each category of information can be further classified into a plurality of sub-categories. For example, the “helping other members” category can further comprise “feedbacks given,” “number of mentees,” “endorsements given,” and other subcategories. As another example, the “self-improvement” category can further comprise “training started,” “skills targeted,” and other subcategories.

In an aspect, the classified information can be assigned a weight. The assigned weight can change based on a specific service request. In an aspect, “helping other members” information can be assigned a higher weight than “self-improvement” information for a service request to identify a candidate for a mentor award. As another example, one or more recent actions (e.g., collaboration actions) can be assigned a higher weight than actions (e.g., collaboration actions) occurred in previous years for a service request to identify a candidate for an award for a current year.

For example, “helping other members” information can comprise a plurality of subcategories:

C₁=360 Feedbacks Given, W_{C}_{₁}=4

C₂=Volunteer to Mentor, W_{C}_{₂}=2

C₃−Number of Mentees, W_{C}_{₃}=4

C₄=Badges Given, W_{C}_{₄}=1

C₅=Endorsements Given, W_{C}_{₅}1

C₆=Thanks Given, W_{C}_{₆}=1.5

C₇=Skills Rated, W_{C}_{₇}=4

C₈=Resources Shared, W_{C}_{₈}=2

C₉=Endorsements for Helping Skills, W_{C}_{₉}=2

Wherein Cₙ represents a number of actions in a respective subcategory of“helping other members” information and W_{Cn} represents a respective weight assigned to the respective subcategory.

For example, “self-improvement” information can comprise a plurality of subcategories:

C₁₀=Number of People Sent Requests to, Wc₁₀=0.5

C₁₁=Mentor Requests Sent, W_{C}_{₁₁}=1

C₁₂=Endorsed for Self Improvement, W_{C}_{₁₂}=1

C₁₃=Career Paths Created, W_{C}_{₁₃}=1

C₁₄=Trainings Started W_{C}_{₁₄}=0.5

C₁₅=Skills Targeted, W_{C}_{₁₅}=0.5

Wherein Cₙ represents a number of actions in a respective subcategory of “self-improvement” information and W_{Cn} represents a respective weight assigned to the respective subcategory.

For example “connectedness” information can comprise a plurality of subcategories:

C₁₆=C_{16b}+(0.8*log(C_{16d})+1), W_{C}_{₁₆}=1

C₁₇=C_{17b}+(0.8*log(C_{17d})+1), W_{C}_{₁₇}=1

C₁₈=C_{18b}+(0.8*log(C_{18d})+1), W_{C}_{₁₈}=2

C₁₉=C_{19b}+(0.8*log(C_{19d})+1), W_{C}_{₁₉}=1

C₂₀=C_{20b}+(0.8*log(C_{20d})+1), W_{C}_{₂₀}=1

C₂₁=C_{21b}+(0.8*log(C_{21d})+1), W_{C}_{₂₁}=1

Wherein Cₙ represents a number of actions in a respective subcategory of “connectedness” information and W_{Cn} represents a respective weight assigned to the respective subcategory and wherein:

C_{16b}=360 Requests Received (# of People)

C_{16d}=360 Requests Received (# of Requests)

C_{17b}=Mentor Requests Received (# of People)

C_{17d}=Mentor Requests Received (# of Requests)

C_{18b}=Endorsed for Influence Skills (# of People)

C_{18d}=Endorsed for Influence Skills (# of Endorsements)

C_{19b}=Thank Yous Received (# of People)

C_{19d}=Thank Yous Received (# of Thanks)

C_{20b}=Endorsement (# of People)

C_{20d}=Endorsements (# of Endorsements)

C_{21b}=Badges Received (# People)

C_{21d}=Badges Received (# of Badges)

At step 406, a collaboration quotient (CQ) can be determined based on the received information using a collaboration module. The collaboration quotient can measure collaborations of a specific member. For example, the collaboration quotient (CQ) can indicate how many actions a member has taken in applications that benefit the member's own career, another member's career, and/or promote potential collaborations between members. As an example, the collaboration module can be configured to calculate the collaboration quotient (CQ). As a specific example, CQ can be calculated by Equation (1):

$${\sum }_{1}^{y} ( {\sum }_{1}^{n} ( \frac{{C}_{u}}{{C}_{{u}_{M}}} * {W}_{{C}_{u}} ) * {2}^{- y} ) \qquad ( 1 )$$

wherein 1 to N represent a plurality of members, n represents the number set 1 to 21 inclusive, y represents a previous date period (e.g., a previous year), Cₙ represents the number of times a member performs collaboration actions in the period, Cₙ_{_{M}} represents the highest count of Cₙ within the plurality of members in the period for an action C, W_{Cn} represents a weight assigned to the action. For each member, i is calculated using Equation (1) which results in population {i₁, i₂, . . . , i_{N}}, wherein iₚ is calculated for the 97% percentile of the population.

CQ can be a number between 1 and 100. For each i that is greater or equal to iₚ, CQ equals 100. For each i that is less than iₚ, CQ can be calculated according to:

$$CQ = 100 \frac{i}{{i}_{o}}$$

In an aspect, a collaboration status for one or more of the plurality of members can be determined based on the determined collaboration quotient. The value of CQ can represent a collaboration status. For example, the collaboration status can comprise entry level, mid-level, high level, advanced level. The CQ and/or collaboration status can help each member of an organization to see how much investment and progress each user is making to benefit his own career, another member's career, and/or promote potential collaborations between members. The CQ and/or collaboration status can also be used to perform social network analysis to identify hubs in an organization (e.g., members who bridge different parts of the organization, people who bridge information between different groups or departments of the organization) and promote collaboration within an organization. In an aspect, the CQ and/or collaboration status can also be used to determine reward points, thank-you points, appreciation points, and the like, associated with a member. In another aspect, CQ and/or the collaboration status can be used as a gauge when a mentor is sought. In another aspect, a hiring manager can use CQ and/or the collaboration status when seeking a candidate for a role or position. In an aspect, CQ can be public information. However, a user cannot derive personal or private information based on CQ or collaboration status.

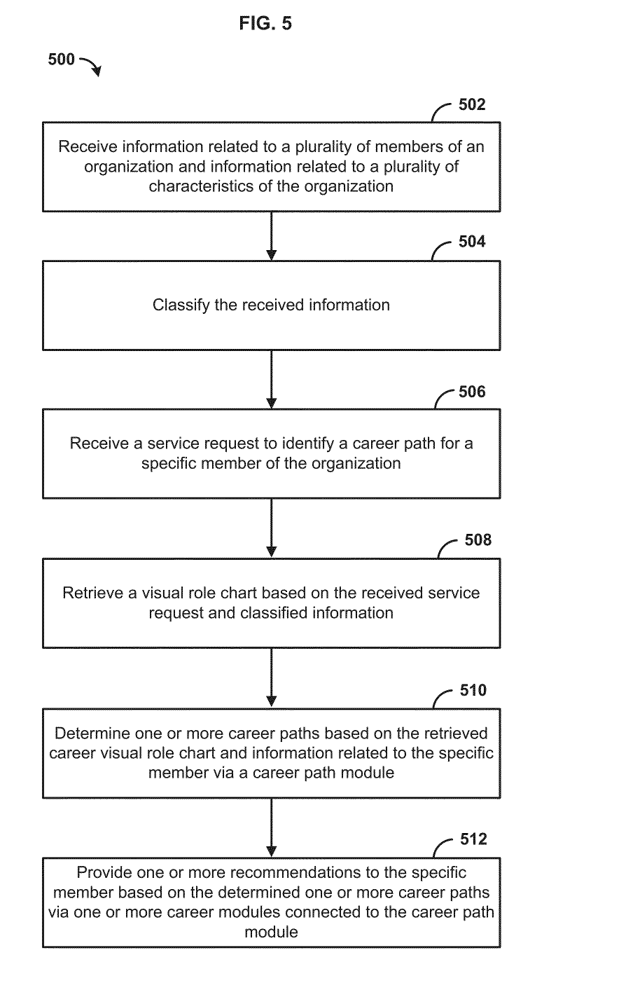

FIG. 5 is a flowchart illustrating an example method 500 for providing management service. At step 502, information related to a plurality of the members of an organization and information related to a plurality of characteristics of the organization can be received. In an aspect, the received information can be stored in a data storage system (e.g., data storage system 105).

In an aspect, the information related to a plurality of members of the organization can comprise member personal information, job related information, education related information, skill related information, and other information. As an example, personal information can comprise information such as name, address, email address, phone number, hobby, role model, and the like. As another example, job related information can comprise information such as current position, team description, career track, career goal, and the like. As another example, skill related information can comprise information such as programming skills, communication skills, language skills, management skills, conceptual thinking skills, conflict resolution skills, and the like. As an example, the information related to the plurality of members of the organization can comprise one or more of a member identifier, name, gender, phone number, address, email address, department number, department description, pay grade, member status (e.g., full time, part time, contractor, volunteer), location, location description, position title, career trajectory, career goal, education level, hobby, achievements, skills, mentoring actions, collaboration actions, feedbacks given, and feedback received, endorsement given, mentor-mentee relationships, and enrolled training courses associated with the respective plurality of members of an organization badges, endorsements, thank-you recognitions. In an aspect, the information related to the plurality of members of an organization can be received from a human resources database. In an aspect, the information related to the plurality of members of the organization can be updated at a predefined frequency (e.g., once a day, once a week, once a month). In another aspect, the information related to the plurality of members of the organization can be updated in real-time (e.g., via logging into a members account). In an aspect, the information related to the plurality of members of the organization can be received from one or more of a survey, a self-evaluation, a peer evaluation associated with the plurality of members, and one or more actions taken by one or more of the plurality of members.

In an aspect, information related to the plurality of characteristics of the organization can comprise a role requirement, a role status, a role skill level requirement, a role family, a role level, a role track, a role discipline, a role location, a certification requirement, a training resource, and a pay level associated with one or more roles within the organization. In an aspect, the information related to the plurality of characteristics of the organization is determined by status, policy and task requirements of the organization.

At step 504, the received information can be classified. For example, a robust skill taxonomy can be used based on the information of the plurality of members to ensure an accurate skill classification. For example, skill information can be categorized as different types of personal skills (e.g., adaptability, discipline, motivation, self-development, etc.), different types of management skills (e.g., oral communications, written communication skills, interpersonal skills, etc.), different types of business skills (e.g., client identification skills, client development skills, event planning skills, etc.), different types of specialty skills (e.g., Java programming skills, C programming skills, data encryption skills, etc.), and the like.

In an aspect, the classified information can be assigned a weight. The assigned weight can change based on a specific service request. As an example, programming skills information can be assigned a higher weight than other skills for a service request to identify a candidate for a programmer position. As another example, communication skills can be assigned a higher weight than other skills if the service request is to identify a candidate for management position. As another example, one or more recent actions (e.g., collaboration actions) can be assigned a higher weight than actions (e.g., collaboration actions) that occurred in previous years if the service request is to identify a candidate for an award for a current year.

At step 506, a service request to identify a career path for a specific member of the organization can be received. In an aspect, once the service request to identify a career path is received, information associated with the specific member can be retrieved from a data storage system. The retrieved information can comprise the specific member's education information, skill information, working history, career goals, or other information.

At step 508, a visual role chart can be retrieved based on the service request and the classified information. In an aspect, the visual role chart can comprise a plurality of career paths within the organization. For example, the visual role chart can comprise one or more career paths between one specific role and one or more other specific roles and time associated with the one or more career paths.

At step 510, one or more career paths can be determined based on the retrieved visual role chart and information related to the specific member using a career path module (e.g. career path module 108). The career path module (e.g., career path module 108) can be used to determine the one or more career paths. One or more career paths can be determined based on comparing (e.g., matching) the education information, working history, career goals and skills associated with the specific member and the retrieved visual role chart. One or more career paths that closely match the specific member's career goals and skills can be identified. In an aspect, identifying one or more career paths can comprise performing a matching analysis (e.g., k-means clustering) based on the information of the specific member and the visual role chart. In an aspect, a matching score can be provided. For example, the career path module can suggest one or more roles along a career path for a member based on the member's current role, future desired role, and a common next role. In an aspect, the member can be connected to one or more open positions that fit the determined career paths for the member.

At step 512, one or more recommendations can be provided to the specific member based on the identified one or more career paths. In an aspect, one or more career resources can be provided to the specific member. For example, when a member's career path is identified, one or more other modules such as the skill gap module 109, the feedback module 110, the mentoring module 111, the training module 112 that are connected to the career path module 108 can be used to provide more information related to gaps and/or opportunities generated by the career path module 108. For example, the skill gap module 109 can provide recommendations on skills that need to be acquired or improved for a specific member based on the identified career path. As another example, the mentoring module 111 can recommend one or more mentors to help the specific member to achieve his career path. For example, a plurality of members currently in the identified “common next role” for the specific member can be identified. The plurality of identified members can be potential mentors for the specific member. As another example, the training module 112 can recommend one or more training courses to fill the skill gap for the specific member to be on his career path.

In an aspect, when a member has mentored a certain number of members, an achievement module (e.g., achievement module 113) can provide an achievement badge (e.g., mentor guru, mentor master, etc.) to the member. The member can choose to display the achievement badge on his profile. Similarly, when a member has formed a certain number of productive collaborations with other members of the organization, the collaboration module can provide a collaboration report for the member (e.g., previous collaborators, etc. . . . ). The member can choose to display the collaboration report. In a further aspect, a member can thank another member through the system. For example, in the event one member helps another member (e.g., as a mentor, on a project, etc. . . . ) the member that was helped can use the system to transmit a virtual thank you to the helping member. The thank you can be in the form of a badge, message, and the like.

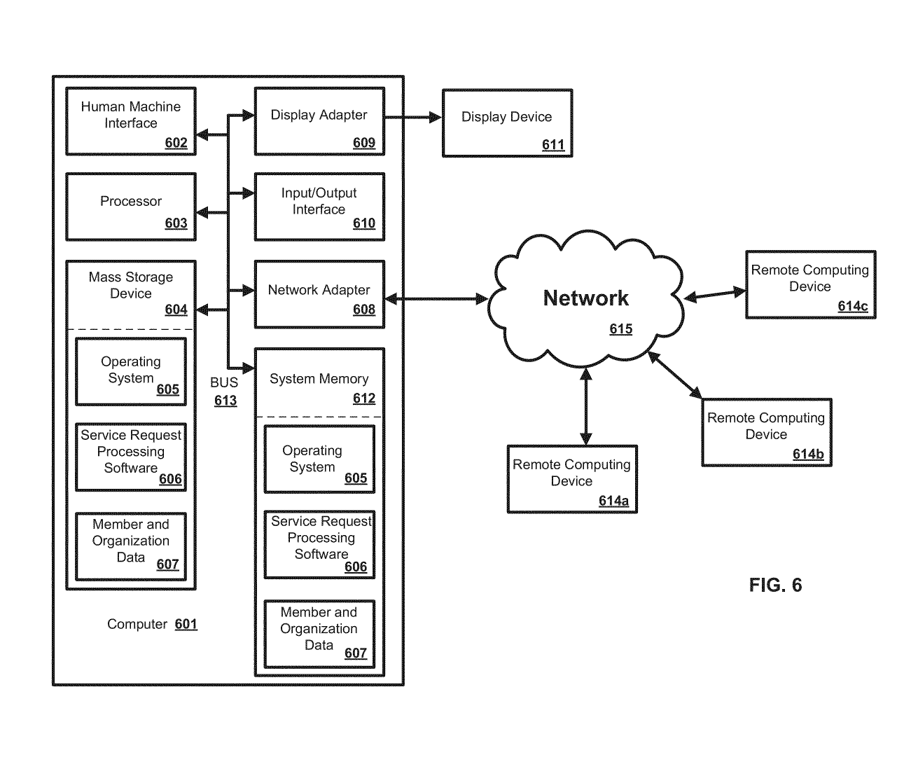

In an exemplary aspect, the methods and systems can be implemented on a computer 601 as illustrated in FIG. 6 and described below. Similarly, the methods and systems disclosed can utilize one or more computers to perform one or more functions in one or more locations. FIG. 6 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to one or a combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 601. The components of the computer 601 can comprise, but are not limited to, one or more processors or processing units 603, a system memory 612, and a system bus 613 that couples various system components including the processor 603 to the system memory 612. In the case of multiple processing units 603, the system can utilize parallel computing.

The system bus 613 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the processor 603, a mass storage device 604, an operating system 605, service request processing software 606, member and organization data 607, a network adapter 608, system memory 612, an Input/Output Interface 610, a display adapter 609, a display device 611, and a human machine interface 602, can be contained within one or more remote computing devices 614a,b,c at physically separate locations, connected through buses of this form, in effect implementing a fully distributed system.

The computer 601 typically comprises a variety of computer readable media. Exemplary readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as member and organization data 607 and/or program modules such as operating system 605 and service request processing software 606 that are immediately accessible to and/or are presently operated on by the processing unit 603.

In another aspect, the computer 601 can also comprise other removable/non-removable, volatile/non-volatile computer storage media. By way of example, FIG. 6 illustrates a mass storage device 604 which can provide non-volatile storage of computer code, computer readable instructions, data structures, program modules, and other data for the computer 601. For example and not meant to be limiting, a mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, an operating system 605 and service request processing software 606. Each of the operating system 605 and service request processing software 606 (or some combination thereof) can comprise elements of the programming and the service request processing software 606. Member and organization data 607 can also be stored on the mass storage device 604. Member and organization data 607 can be stored in any of one or more databases known in the art. Examples of such databases comprise, DB2®, Microsoft Access, Microsoft® SQL Server, Oracle®, mySQL, PostgreSQL, and the like. The databases can be centralized or distributed across multiple systems.

In another aspect, the user can enter commands and information into the computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 603 via a human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, a display device 611 can also be connected to the system bus 613 via an interface, such as a display adapter 609. It is contemplated that the computer 601 can have more than one display adapter 609 and the computer 601 can have more than one display device 611. For example, a display device can be a monitor, an LCD (Liquid Crystal Display), or a projector. In addition to the display device 611, other output peripheral devices can comprise components such as speakers (not shown) and a printer (not shown) which can be connected to the computer 601 via Input/Output Interface 610. Any step and/or result of the methods can be output in any form to an output device. Such output can be any form of visual representation, including, but not limited to, textual, graphical, animation, audio, tactile, and the like. The display 611 and computer 601 can be part of one device, or separate devices.

The computer 601 can operate in a networked environment using logical connections to one or more remote computing devices 614a,b,c. By way of example, a remote computing device can be a personal computer, portable computer, smartphone, a server, a router, a network computer, a peer device or other common network node, and so on. Logical connections between the computer 601 and a remote computing device 614a,b,c can be made via a network 615, such as a local area network (LAN) and/or a general wide area network (WAN). Such network connections can be through a network adapter 608. A network adapter 608 can be implemented in both wired and wireless environments. Such networking environments are conventional and commonplace in dwellings, offices, enterprise-wide computer networks, intranets, and the Internet

For purposes of illustration, application programs and other executable program components such as the operating system 605 are illustrated herein as discrete blocks, although it is recognized that such programs and components reside at various times in different storage components of the computing device 601, and are executed by the data processor(s) of the computer. An implementation of service request processing software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving information related to a plurality of the members of an organization and information related to a plurality of characteristics of the organization;
classifying the received information;
receiving a service request related to the organization or to one or more of the plurality of members of the organization;
identifying a module from a plurality of modules to process the service request, wherein the plurality of modules are interconnected;
generating a result via processing the service request based on the classified information using the identified module; and
providing one or more recommendations based on the generated result using one or more of the plurality of modules connected to the identified module.

2. The method of claim 1, wherein the plurality of modules comprises a career path module, a skill gap module, a feedback module, a mentoring module, a training module, an achievement module, and a collaboration module.

3. The method of claim 1, wherein the information related to the plurality of the members of the organization is updated in real time.

4. The method of claim 1, wherein the information related to the plurality of members of the organization comprises one or more of a member identifier, name, gender, phone number, address, email address, department number, department description, pay grade, status, location, location description, position title, manager's name, career trajectory, career goal, education level, hobby, achievements, skills, mentoring actions, collaboration actions, feedbacks associated with the respective plurality of members of the organization, badges, endorsements, thank-you recognitions.

5. The method of claim 1, wherein the information related to the plurality of characteristics of the organization comprises a role requirement, a role status, a role skill level requirement, a role family, a role level, a role track, a role discipline, a role location, a certification requirement, a training resource, and a pay level associated to one or more roles within the organization.

6. The method of claim 1, wherein the service request related to one or more of the plurality of members of the organization comprises one or more of: determining a career path, identifying a member as a candidate for a specific position, determining a contribution of a member, determining one or more members for a specific task, determining a promotion for a member, evaluating a member, rewarding a member, connecting one or more members with one or more specific common interests, skills, and career goals, connecting one or more members to one or more open positions, identifying one or more skills for a member to develop, providing a resource for a member, connecting one or more members who need to develop a skill to one or more members who have the skill, connecting two or more members for a specific purpose, requesting feedback, receiving feedback, analyzing team strength and development needs.

7. The method of claim 1, wherein the information related to the plurality of members of the organization is received from one or more of a survey, a self-evaluation, a peer evaluation associated with the plurality of members, and one or more actions taken by one or more of the plurality of members.

9. The method of claim 1, wherein the information related to the plurality of characteristics of the organization is determined by status and policy of the organization.

10. The method of claim 1, wherein classifying the received information comprises creating a skill taxonomy based on the information of the plurality of members.

11. A method comprising:
receiving information related to a plurality of the members of an organization and information related to a plurality of characteristics of the organization;
classifying the received information; and
determining a collaboration quotient for one or more of the plurality of members based on the classified information using a collaboration module.

12. The method of claim 11, wherein the information related to the plurality of members of the organization comprises one or more of a member identifier, name, gender, phone number, address, email address, department number, department description, pay grade, status, location, location description, position title, manager's name, career trajectory, career goal, education level, hobby, achievements, skills, mentoring actions, collaboration actions, feedbacks given, and feedback received, endorsement given, mentor-mentee relationships, and enrolled training courses associated with the respective plurality of members of the organization badges, endorsements, thank-you recognitions, training courses taken.

13. The method of claim 11, wherein the information related to the plurality of the members of the organization is assigned to a plurality of weights.

14. The method of claim 11, wherein the information related to a plurality of members of the organization is received from one or more of a survey, a self-evaluation, a peer evaluation, and or more actions taken by one or more of the plurality of members.

15. The method of claim 11, further comprising:
determining one or more of a reward, an appreciation point, a badge, an endorsement for one or more of the plurality of members and a candidate for specific role, via analyzing the collaboration quotient for one or more of the plurality of members.

16. A method comprising:
receiving information related to a plurality of the members of an organization and information related to a plurality of characteristics of the organization;
classifying the received information;
receiving a service request to identify a career path for a specific member of the organization;
retrieving a visual role chart based on the received service request and classified information;
determining one or more career paths based on the retrieved visual role chart and information related to the specific member via a career path module; and
providing one or more recommendations to the specific member based on the determined one or more career paths via one or more modules connected to the career path module.

17. The method of claim 16, wherein the information related to the plurality of members of the organization comprises one or more of a member identifier, name, gender, phone number, address, email address, department number, department description, pay grade, status, location, location description, position title, manager's name, career trajectory, career goal, education level, hobby, achievements, skills, mentoring actions, collaboration actions, feedbacks given, and feedback received, endorsement given, mentor-mentee relationships, and enrolled training courses associated with the respective plurality of members of the organization.

18. The method of claim 16, wherein the information related to the plurality of characteristics of the organization comprises a role requirement, a role status, a role skill level requirement, a role family, a role level, a role track, a role discipline, a role location, a certification requirement, a training resource, and a pay level associated to one or more roles within the organization.

19. The method of claim 16, wherein the information related to a plurality of members of the organization is received from one or more of a survey, a self-evaluation, a peer evaluation and or more actions taken by one or more of the plurality of members.

20. The method of claim 16, wherein providing one or more recommendations comprises recommending a plurality of skills improvements, one or more mentors, and one or more training sessions.
